(19) United States
(12) Patent Application Publication
(10) Pub. No.: US 2025/0124260 A1
(43) Pub. Date: Apr. 17, 2025

(54) POPULATION STATE DETERMINATION SYSTEM AND MODEL GENERATION SYSTEM

(71) Applicant: NTT DOCOMO, INC., Tokyo (JP)

(72) Inventors: Keiichi OCHIAI, Chiyoda-ku (JP); Masayuki TERADA, Chiyoda-ku (JP)

(73) Assignee: NTT DOCOMO, INC., Tokyo (JP)

(21) Appl. No.: 18/703,771

(22) PCT Filed: Aug. 30, 2022
(86) PCT No.: PCT/JP2022/032591

§ 371 Date: Apr. 23, 2024

(30) Foreign Application Priority Data
Nov. 15, 2021 (JP) 2021-185665

(51) Int. Cl. G06N 3/0455

(52) U.S. Cl. CPC G06N 3/0455

(57) ABSTRACT

A population state determination system includes an acquisition unit configured to acquire population information indicating a population in a time series in an area that is a population state determination target, a model calculation unit configured to perform calculation by inputting the population information acquired by the acquisition unit to a pre-stored encoder-decoder model for compressing and reconstructing input data and obtain an output from the encoder-decoder model, and a determination unit configured to determine a state of the population in the area by comparing the population information acquired by the acquisition unit-11 with the output obtained by the model calculation unit.

### TECHNICAL FIELD

The present invention relates to a population state determination system for determining a state of a population in an area and a model generation system for generating an encoder-decoder model.

### BACKGROUND ART

Conventionally, technology for estimating a population in each area and time period using data of a portable terminal such as a portable phone has been proposed (see, for example, Patent Literature 1).

### CITATION LIST

### Patent Literature

[Patent Literature 1] Japanese Unexamined Patent Publication No. 2020-123011

### SUMMARY OF INVENTION

### Technical Problem

Using information of the above-described estimated population, it is possible to detect an area where the population is abnormal, such as a population greater than that during normal times. Thereby, it is possible to detect sudden events and to discover places where many people are staying during a disaster.

As an abnormal population detection method, there is a statistical method based on the average and variance of the population in a certain area and time period. In this method, an abnormality can be detected in a certain area and time period. However, this method does not take into account population changes and cannot necessarily detect abnormalities with high accuracy.

An embodiment of the present invention has been made in view of the above and an objective of the present invention is to provide a population state determination system capable of appropriately determining a state of a population and a model generation system pertaining to the determination of a population.

### Solution to Problem

To accomplish the above-described objective, according to an embodiment of the present invention, there is provided a population state determination system including: an acquisition unit configured to acquire population information indicating a population in a time series in an area that is a population state determination target; a model calculation unit configured to perform calculation by inputting the population information acquired by the acquisition unit to a pre-stored encoder-decoder model for compressing and reconstructing input data and obtain an output from the encoder-decoder model; and a determination unit configured to determine a state of the population in the area by comparing the population information acquired by the acquisition unit with the output obtained by the model calculation unit.

The population state determination system according to the embodiment of the present invention can determine the state of the population considering the population in the time series in the area. Moreover, the input for the encoder-decoder model is compared with the output and determination is made. Therefore, the population state determination system according to the embodiment of the present invention can appropriately determine the state of the population.

According to an embodiment of the present invention, there is provided a model generation system including: a learning acquisition unit configured to acquire population information for learning indicating a population in a time series for use in generating an encoder-decoder model for compressing and reconstructing input data; and a model generation unit configured to generate the encoder-decoder model for inputting information indicating a population in a time series by performing machine learning on the basis of the population information for learning acquired by the learning acquisition unit.

The model generation system according to the embodiment of the present invention can generate the encoder-decoder model for use in the population state determination system.

### Advantageous Effects of Invention

According to an embodiment of the present invention, it is possible to appropriately determine a state of a population.

### BRIEF DESCRIPTION OF DRAWINGS

FIG. 1 is a diagram showing a configuration of a computer that is a population state determination system and a model generation system according to an embodiment of the present invention.

FIG. 2 is a graph of an example of population information and an output value from an encoder-decoder model of a case where the population information is used as an input value.

FIG. 3 is a diagram showing an example of information for use in a computer.

FIG. 4 is a diagram schematically showing an example of an encoder-decoder model generated and used by the computer.

FIG. 5 is a diagram schematically showing another example of an encoder-decoder model generated and used by the computer.

FIG. 6 is a diagram showing an example of information for use in the computer.

FIG. 7 is a flowchart showing a process executed in the model generation system according to the embodiment of the present invention.

FIG. 8 is a flowchart showing a process executed by the population state determination system according to the embodiment of the present invention.

FIG. 9 is a diagram showing a hardware configuration of the computer that is the population state determination system and the model generation system according to the embodiment of the present invention.

### DESCRIPTION OF EMBODIMENTS

Hereinafter, embodiments of a population state determination system and a model generation system according to the present invention will be described in detail with reference to the accompanying drawings. In the description of the drawings, the same reference signs are used for the same elements and redundant description thereof will be omitted.

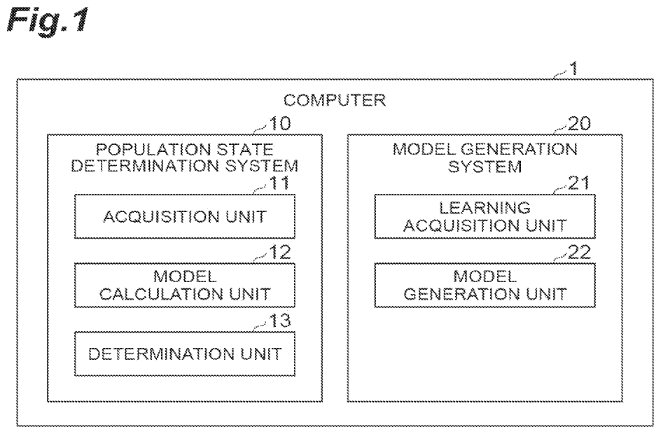

A computer 1 that is a population state determination system 10 and a model generation system 20 according to the present embodiment is shown in FIG. 1. The population state determination system 10 is a system (device) for determining (estimating) a state of a population in a geographical area. An area that is a determination target is, for example, a 500 m square area obtained by dividing a region. A standard regional mesh or a one-half regional mesh may be used as the area. Moreover, as the area, an administrative division such as a municipality or a prefecture, or a preset land use division may be used. In the following description, the area will be described as a mesh. Also, the area that is the determination target does not have to be the above and can be any geographical area.

The determination of the population state determination system 10 is performed on the basis of population information indicating a population in a time series in the area that is the determination target. For example, in the determination, population information indicating an hourly population on a daily basis is used as described below. The determination is, for example, the determination of whether or not the population in the area that is the determination target is in an abnormal state different from a state during normal times. That is, the determination is a process of detecting an abnormality in the population change in the area that is the determination target. An abnormal state in which the population is different from that at normal times is, for example, a state in which the population change is excessively different from the population change during normal times. According to the above determination, for example, it is possible to detect sudden events or to discover a place where many people are staying in the event of a disaster. Also, the determination of the population state determination system 10 may be the determination of an abnormality degree instead of the determination of whether or not there is an abnormal state. Alternatively, the determination of the population state determination system 10 may be something other than the above as long as it is the determination of the population state in the area.

As will be described below, the determination of the population state determination system 10 is performed by performing calculation using an encoder-decoder model that is a trained model generated in machine learning on the population information. The encoder-decoder model is a model for compressing and reconstructing input data. The model generation system 20 generates an encoder-decoder model for use in the determination of the population state determination system 10.

A conventional computer can be used as the computer 1 that is the population state determination system 10 and the model generation system 20 according to the present embodiment. Moreover, the computer 1 may be a computer system including a plurality of computers.

Next, functions of the population state determination system 10 and the model generation system 20 according to the present embodiment will be described. First, the function of the model generation system 20 will be described and then the function of the population state determination system 10 will be described. As shown in FIG. 1, the model generation system 20 is configured to include a learning acquisition unit 21 and a model generation unit 22.

The learning acquisition unit 21 is a functional unit that acquires population information for learning indicating a population in a time series for use in generating an encoder-decoder model. The learning acquisition unit 21 may acquire type information for learning indicating a type of area pertaining to the population information for learning. The learning acquisition unit 21 may acquire type information for learning by performing clustering using population information for learning. The learning acquisition unit 21 acquires information as follows.

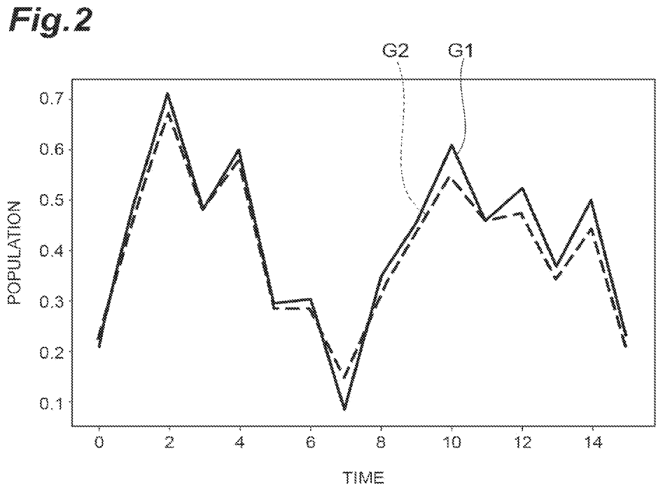

Individual population information for learning is information having a format similar to that of population information for use in the determination of the state of the population. For example, the population information is information indicating the population in an area at every hour of the day (00:00, 01:00, . . . , 23:00). In FIG. 2, a part of a graph G1 of an example of the population information is shown. When such population information is used, the population state determination system 10 determines the population state of the area that is the determination target on that day. Also, an overall time period (1 day in the above example), a time interval (every hour in the above example), and a format of the population information that is the determination target may not necessarily be the above.

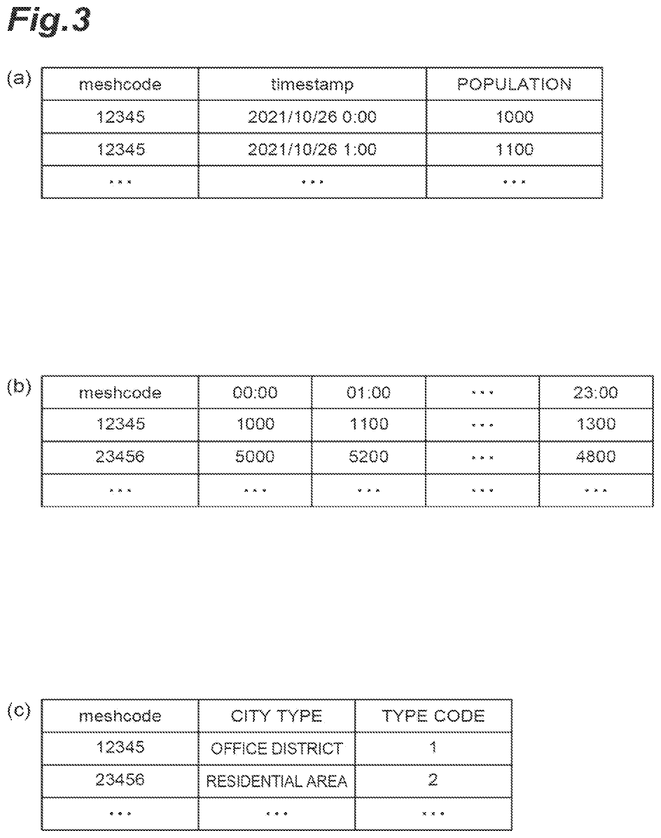

A large amount of population information for learning is used to generate the encoder-decoder model. A large amount of population information for learning usually includes population information for learning pertaining to a plurality of areas. The learning acquisition unit 21 acquires, for example, data shown in FIG. 3(a). The data shown in FIG. 3(a) is information in which a mesh code (information in a “meshcode” field), information indicating a time (information in a “timestamp” field), and information indicating a population (information in a “population” field) are associated. The mesh code is information such as a character string for identifying a mesh that is an area and is set in advance for each area. The information indicating the time is, for example, information indicating the year, month, day, and time of the day. The information indicating the population indicates the population in the area and time indicated in information indicating the corresponding mesh code and time.

The data pertaining to the population shown in FIG. 3(a), for example, is generated as spatial statistical information from information indicating a position of a portable phone and information registered for a subscriber of the portable phone in an existing method. Moreover, the data pertaining to the population shown in FIG. 3(a) may be generated in any method other than the above. The learning acquisition unit 21 acquires data pertaining to the population shown in FIG. 3(a) stored in advance in the database of the computer 1 or another device.

As shown in FIG. 3(b), the learning acquisition unit 21 formats the acquired data into data for each mesh code and every hour (00:00, 01:00, . . . , 23:00) on a daily basis, i.e., daily population change data in units of areas. This population change data corresponds to population information for learning. The learning acquisition unit 21 acquires a sufficient amount of population change data for generating an encoder-decoder model in machine learning. The population change data may or may not include data in the area that is a population state determination target. Also, the learning acquisition unit 21 may acquire information indicating a population in a time series other than the above as population information for learning.

The learning acquisition unit 21 may be configured to acquire type information for learning indicating a type of area pertaining to the population change data. The type of area is a type that can affect the population change in the area. For example, types of areas are city types such as “office district” and “residential area.”

For example, the learning acquisition unit 21 acquires type information for learning stored in advance in the database of the computer 1 or another device. In FIG. 3(c), an example of data that is type information for learning stored in advance is shown. The data shown in FIG. 3(c) is information in which a mesh code (information in a “meshcode” field), information indicating a city type (information in a “city type” field), and a type code (information in a “type code” field) are associated. The information indicating the city type is information indicating the meaning of a type of area indicated in the corresponding mesh code. The information indicating the city type is set in advance for each area. Also, because the information indicating the city type may not be used for processing in the model generation system 20, it may not be acquired.

The type code is information (a flag indicating an area) for identifying a type of area indicated in the corresponding mesh code and is set in advance for each area. The type code is a numerical value that can be used for machine learning. The type code is the same numerical value for the same city type and a different numerical value for a different city type. The learning acquisition unit 21 acquires a type code corresponding to the mesh code of the area pertaining to the population change data as type information for learning.

The learning acquisition unit 21 may acquire the type information for learning by performing clustering using population information for learning instead of acquiring type information for learning stored in advance. The learning acquisition unit 21 performs clustering using daily population change data in the above units of areas. For example, as shown below, the learning acquisition unit 21 performs area clustering using daily population change data in the above units of areas. By performing such clustering, it is possible to divide areas with similar population changes into clusters.

The learning acquisition unit 21 takes the average of the population for each time in units of areas and generates one item of population change data for one area. For example, the learning acquisition unit 21 takes a time-by-time average of daily population change data for a preset period for each area (e.g., a period from one month before the current time to the current time) and generates one item of population change data for each area. The learning acquisition unit 21 clusters the population change data and performs area clustering. The clustering itself can be performed using a conventional method (e.g., the k-means clustering).

Alternatively, the learning acquisition unit 21 may cluster population change data that can include a plurality of items of population change data for one area. The learning acquisition unit 21 designates a cluster containing the most population change data for each area as a cluster in the area.

The learning acquisition unit 21 assigns a unique type code (cluster number) to each cluster. The learning acquisition unit 21 designates the type code of the cluster to which the area belongs as type information for learning pertaining to the area. The learning acquisition unit 21 stores the association between the mesh code and the type code for each area in the computer 1 and makes it available in the population state determination system 10. Also, when the type information for learning is acquired by performing clustering, there is no information indicating the city type.

The learning acquisition unit 21 outputs the acquired population information for learning to the model generation unit 22. Moreover, in a mode in which the type information for learning is acquired, the learning acquisition unit 21 also outputs the acquired type information for learning to the model generation unit 22.

The model generation unit 22 is a functional unit that performs machine learning on the basis of the population information for learning acquired by the learning acquisition unit 21 and generates an encoder-decoder model to which information indicating a population in a time series is input. The model generation unit 22 may generate an encoder-decoder model on the basis of the type information for learning acquired by the learning acquisition unit 21. The model generation unit 22 may generate an encoder-decoder model to which type information indicating a type of area is also input. The model generation unit 22 may generate a plurality of encoder-decoder models corresponding to the type information indicating the type of area.

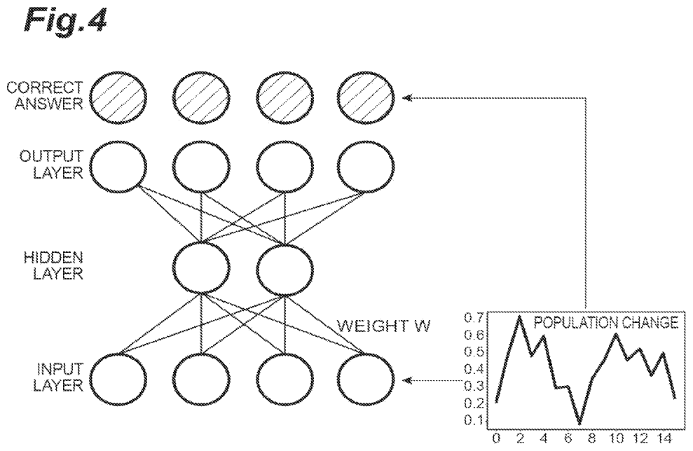

The encoder-decoder model generated by the model generation unit 22 will be described. In FIG. 4, an example of the encoder-decoder model is shown. The encoder-decoder model includes a neural network and is a trained model that has been trained to input population information indicating a population in a time series in an area, perform dimensional compression, and then output original population information. Encoder-decoder models include autoencoders (Geoffrey Hinton and Salakhutdinov Ruslan, “Reducing the Dimensionality of Data with Neural Networks” Science, pp. 504-507, 2006), a transformer (Ashish Vaswani et al., “Attention Is All You Need” Advances in neural information processing system 2017), and the like. In the input layer of the encoder-decoder model, neurons of the number of elements of population information (the number of dimensions of population information) are provided. When the population information is information (a numerical value) indicating the population of an area every hour of the day (00:00, 01:00, . . . , 23:00), 24 neurons (vectors) for inputting a numerical value of the population of the area for each hour are provided in the input layer of the encoder-decoder model. The output layer of the encoder-decoder model includes neurons (vectors) corresponding to neurons of the input layer and equal in number to the neurons of the input layer.

The configuration of the encoder-decoder model itself may be similar to that of the conventional encoder-decoder model. As shown in FIG. 4, a hidden layer in which a plurality of neurons (vectors) are provided is provided between the input layer and the output layer. Each neuron in the input layer is connected to each neuron in the hidden layer with a weight w that is used for calculation. Moreover, each neuron in the hidden layer is connected to each neuron in the output layer with a weight w that is used for calculation. The number of neurons provided in the hidden layer is less than the number of neurons in the input layer and the output layer. Thereby, dimensional compression is performed in the hidden layer.

The model generation unit 22 generates an encoder-decoder model as follows. First, an example of a mode in which type information for learning is not used will be described and then an example of a mode in which type information for learning is used will be described.

The model generation unit 22 inputs population change data that is population information for learning from the learning acquisition unit 21. As shown in FIG. 4, the model generation unit 22 performs machine learning to generate the encoder-decoder model, using the population change data as both input values for the encoder-decoder model and output values (correct answer) of the encoder-decoder model. The above-described machine learning itself, which generates the encoder-decoder model, can be performed as in a conventional machine learning method. The above is an example of a case where the type information for learning is not used.

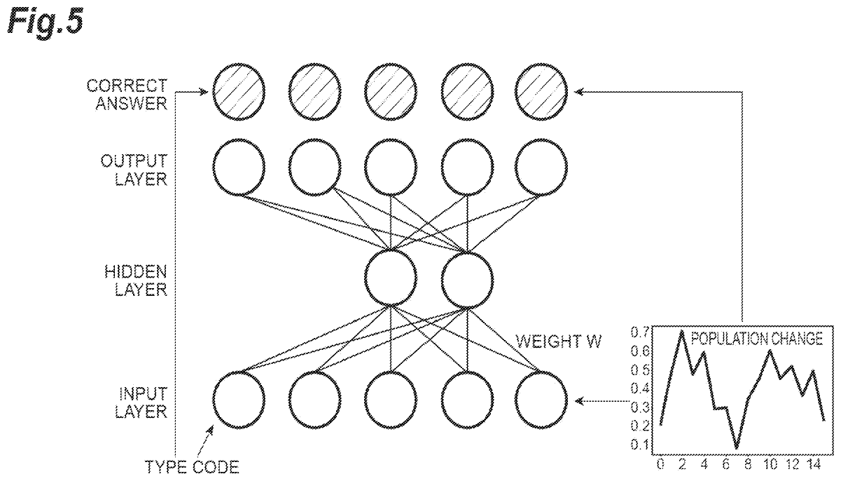

Subsequently, an example of a mode in which type information for learning is used will be described. The model generation unit 22 inputs a type code that is type information for learning together with population change data from the learning acquisition unit 21. In this case, the model generation unit 22 generates an encoder-decoder model to which a type code is also input. In FIG. 5, an example of this encoder-decoder model is shown. In addition to the encoder-decoder model shown in FIG. 4, this encoder-decoder model is provided with neurons corresponding to the type code in the input layer and the output layer.

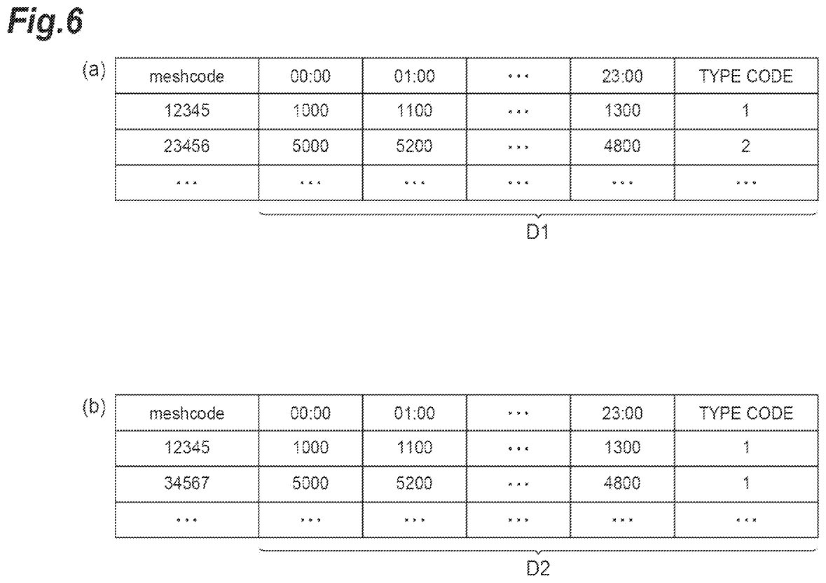

As shown in FIG. 6(a), the model generation unit 22 associates a type code of an area with population change data for each area and each day. This mapping is performed using the mesh code as a key. As shown in FIG. 5, the model generation unit 22 performs machine learning to generate the encoder-decoder model, using the population change data and the type code that have been associated with each other (data D1 shown in FIG. 6(a)) as both input values for the encoder-decoder model and output values (correct answer) of the encoder-decoder model.

Moreover, the model generation unit 22 may generate a plurality of encoder-decoder models corresponding to the type code. For example, the model generation unit 22 may generate an encoder-decoder model for each type code. The model generation unit 22 uses population change data for each area and each day of the same type code as shown in FIG. 6(b) to generate one encoder-decoder model. That is, the model generation unit 22 filters the population change data for each type code and uses the filtered population change data to generate the encoder-decoder model.

In this case, the model generation unit 22 may generate an encoder-decoder model to which only the population change data as shown in FIG. 4 is input (an encoder-decoder model that does not use a type code as an input). The model generation unit 22 performs machine learning to generate the encoder-decoder model, using the population change data as both input values for the encoder-decoder model and output values (correct answer) of the encoder-decoder model.

Alternatively, the model generation unit 22 may generate an encoder-decoder model to which a type code is also input in addition to the population change data as shown in FIG. 5. At this time, the model generation unit 22 performs machine learning to generate the encoder-decoder model, using the population change data and the type code that have been associated with each other (data D2 shown in FIG. 6(b)) as both input values for the encoder-decoder model and output values (correct answer) of the encoder-decoder model. The model generation unit 22 performs the machine learning as described above for each type code to generate the encoder-decoder model for each type code.

The model generation unit 22 outputs the generated encoder-decoder model to the population state determination system 10. When an encoder-decoder model has been generated for each type code, the model generation unit 22 also outputs the type code corresponding to each encoder-decoder model to the population state determination system 10. The above is the function of the model generation system 20 according to the present embodiment.

Next, the function of the population state determination system 10 will be described. As shown in FIG. 1, the population state determination system 10 is configured to include an acquisition unit 11, a model calculation unit 12, and a determination unit 13.

The acquisition unit 11 is a functional unit that acquires population information indicating a population in a time series in an area that is a population state determination target. The acquisition unit 11 acquires the above-described population information for the area and the time period that are the determination target. The acquisition unit 11 may acquire type information indicating a type of area that is a population state determination target.

For example, the acquisition unit 11 receives a designation of the area and time period (date) that are the determination target and from a user of the population state determination system 10 and acquires population information pertaining to the designated area and time period as in the acquisition of population information for learning by the learning acquisition unit 21 described above.

The acquisition unit 11 may be configured to acquire type information indicating a type of area that is a population state determination target. The acquisition unit 11 acquires type information identical to the type information for learning acquired by the learning acquisition unit 21 for the area pertaining to the acquired population information. For example, when the learning acquisition unit 21 acquires the type information for learning stored in advance as shown in FIG. 3(c) described above, the acquisition unit 11 acquires a type code corresponding to the mesh code of the area pertaining to population information from the same information as the type information.

Moreover, when clustering has been performed by the learning acquisition unit 21, the acquisition unit 11 acquires a type code corresponding to the mesh code of the area pertaining to population information as type information from the information on the association between the mesh code and the type code stored in the computer 1 as a result of clustering.

The acquisition unit 11 outputs the acquired population information to the model calculation unit 12 and the determination unit 13. Moreover, when the type information is acquired, the acquisition unit 11 also outputs the acquired type information to the model calculation unit 12.

The model calculation unit 12 is a functional unit for inputting the population information acquired by the acquisition unit 11 to the encoder-decoder model stored in advance, performing calculation, and obtaining an output from the encoder-decoder model. The model calculation unit 12 may perform calculation using the encoder-decoder model on the basis of the type information acquired by the acquisition unit 11. The model calculation unit 12 may also input type information to the encoder-decoder model and obtain an output from the encoder-decoder model. On the basis of the type information, the model calculation unit 12 may select an encoder-decoder model for use in calculation from a plurality of encoder-decoder models stored in advance and perform calculation using the selected encoder-decoder model.

The model calculation unit 12 inputs and stores the encoder-decoder model generated by the model generation system 20. The model calculation unit 12 inputs population information from the acquisition unit 11.

The model calculation unit 12 uses the population information as input values for the encoder-decoder model, performs calculation using the weights w of the encoder-decoder model, and obtains output values from the encoder-decoder model. The output values from the encoder-decoder model are reconstructed data of population change data, which is the population information, and are information having a format similar to that of the population information. A graph G2 of an example of output values when the population information shown in the graph G1 shown in FIG. 2 is used as an input value is shown.

In a mode in which the type information is used, the model calculation unit 12 inputs the type information from the acquisition unit 11 and performs the following process. In this case, for example, as described above, an encoder-decoder model to which type information is also input is generated by the model generation system 20. The model calculation unit 12 uses population information and type information as input values for the encoder-decoder model, performs calculation using the weights w of the encoder-decoder model, and obtains output values from the encoder-decoder model.

Moreover, in this case, for example, as described above, a plurality of encoder-decoder models corresponding to the type code are generated by the model generation system 20. The model calculation unit 12 selects an encoder-decoder model corresponding to a type code that is input type information from the plurality of encoder-decoder models. The model calculation unit 12 obtains output values from the encoder-decoder model as described above using the selected encoder-decoder model.

The model calculation unit 12 outputs the obtained output values from the encoder-decoder model to the determination unit 13. Also, the output values output to the determination unit 13 may be only a part corresponding to the population information.

The determination unit 13 is a functional unit that determines a state of a population in an area by comparing the population information acquired by the acquisition unit 11 with the output obtained by the model calculation unit 12. The determination of the determination unit 13 is, for example, the determination of whether or not the population in the area that is the determination target is in an abnormal state different from a state during normal times as described above. However, as long as the determination can be made by comparing the population information input to the encoder-decoder model with the output from the encoder-decoder model, determination other than the above may be used. The determination unit 13 determines the state of the population in the area as follows.

The determination unit 13 inputs population information from the acquisition unit 11. The determination unit 13 inputs output values corresponding to the population information from the model calculation unit 12. The determination unit 13 compares the input for the encoder-decoder model (the population change data, for example, the graph G1 in FIG. 2) with the output from the encoder-decoder model (the reconstructed data of the population change data, for example, the graph G2 in FIG. 2) and calculates an error as an abnormality degree. For example, the determination unit 13 calculates an absolute value of a difference between the input and the output of each time period for each hour and designates a sum of all time periods as the error.

The determination unit 13 compares the calculated error with a preset threshold value. If the error is greater than or equal to the threshold value, the determination unit 13 determines that the population in the area that is the determination target is in an abnormal state. In this case, it is estimated that a phenomenon different from that during normal times such as an event has occurred in the area that is the determination target. If the error is not greater than or equal to the threshold value, the determination unit 13 determines that the population in the area that is the determination target is not in an abnormal state.

The above-described determination takes advantage of the fact that abnormal data cannot be suitably reconstructed when input to the encoder-decoder model when the encoder-decoder model is generated in machine learning using only normal data. Therefore, the normal times pertaining to the determination are characterized by the population information for learning used when the encoder-decoder model is generated in the model generation system 20.

The determination unit 13 outputs information indicating a determination result. For example, the determination unit 13 may cause the display device provided in the computer 1 to display the determination result so that the user can refer to the determination result. Alternatively, the determination unit 13 may transmit information indicating the determination result to another device. Moreover, the determination unit 13 may output information indicating the determination result to an output destination other than the above in a method other than the above. The above is the function of the population state determination system 10 according to the present embodiment.

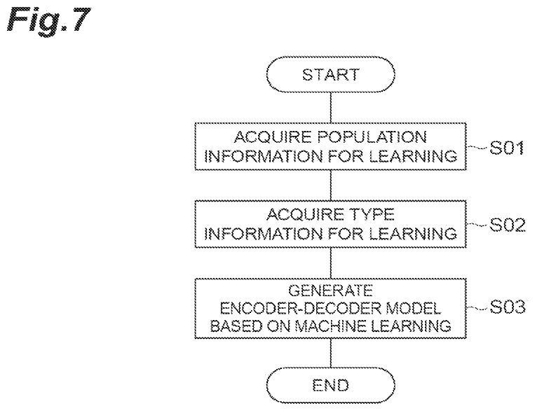

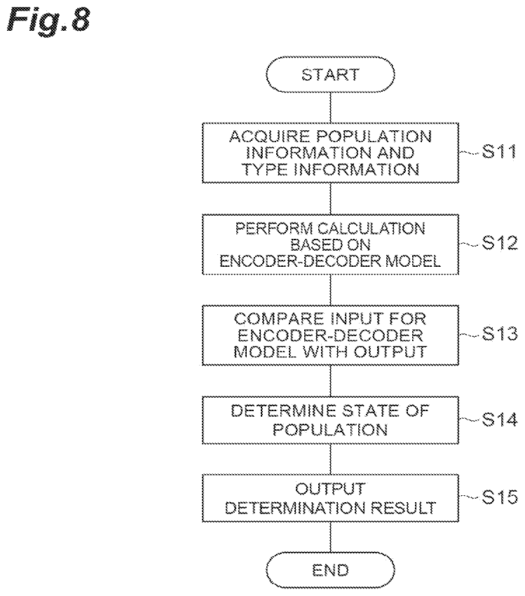

Next, a process executed by the computer 1 according to the present embodiment (an operation method performed by the computer 1) will be described with reference to the flowcharts of FIGS. 7 and 8. First, the process executed by the model generation system 20 will be described using the flowchart of FIG. 7.

In the present process, first, population information for learning is acquired by the learning acquisition unit 21 (S01). Subsequently, type information for learning is acquired by the learning acquisition unit 21 (S02). Also, in a mode in which the type information for learning is not used, the acquisition of the type information for learning (S02) may not be performed. Subsequently, the model generation unit 22 performs machine learning based on the population information for learning to generate an encoder-decoder model (S03). Moreover, in a mode in which the type information for learning is used, an encoder-decoder model is generated on the basis of the type information for learning. The generated encoder-decoder model is output to the population state determination system 10 and stored by the model calculation unit 12. The above is a process executed by the model generation system 20 according to the present embodiment.

Next, the process executed by the population state determination system 10 will be described using the flowchart of FIG. 8. In the present process, first, population information and type information are acquired by the acquisition unit 11 (S11). Also, in a mode in which type information is not used, the type information may not be acquired. Subsequently, the model calculation unit 12 inputs population information to the encoder-decoder model, performs calculation, and obtains an output from the encoder-decoder model (S12). Moreover, in the mode in which the type information is used, calculation using an encoder-decoder model is performed on the basis of the type information.

Subsequently, the determination unit 13 compares the input for the encoder-decoder model with the output from the encoder-decoder model (S13). Subsequently, the determination unit 13 determines a state of a population in an area on the basis of the above-described comparison (S14). Subsequently, information indicating the determination result is output by the determination unit 13 (S15). The above is a process executed by the population state determination system 10 according to the present embodiment.

According to the population state determination system 10 according to the present embodiment, because time-series population information is used, it is possible to determine a state of a population considering a time-series population in an area. Moreover, the input for the encoder-decoder model is compared with the output and the determination is made. Therefore, the population state determination system 10 according to the present embodiment can appropriately determine the population state with high accuracy.

Moreover, type information may be used as in the above-described embodiment. By using the type information, it is possible to appropriately determine the state of the population in accordance with the characteristics of the area. For example, the determination can be made in consideration of the functional characteristics of a city such as an office district or a residential area. Thereby, it is possible to perform determination more accurately and appropriately than determination according to an average population change that does not take into account type information.

As a method using the type information, it may be input to the encoder-decoder model as described above. Moreover, an encoder-decoder model for use in calculation may be selected on the basis of the type information. According to such configurations, the type information can be used reliably and appropriately and determination can be made reliably and appropriately. However, the type information may be used in a method other than the above. Moreover, type information does not necessarily need to be used.

The model generation system 20 according to the present embodiment can generate an encoder-decoder model for use in the population state determination system 10. Moreover, when the encoder-decoder model is generated, the type information for learning corresponding to the type information may be used. Moreover, the type information for learning may be acquired by performing clustering using population information for learning as described above. According to this configuration, even if the type information is not associated with the area in advance, the generation of an encoder-decoder model based on the type of area and the determination using the encoder-decoder model can be performed.

Also, in the present embodiment, the computer 1 includes the population state determination system 10 and the model generation system 20, but the population state determination system 10 and the model generation system 20 may be implemented independently of each other.

Also, the block diagrams used to describe the above embodiments show blocks in functional units. These functional blocks (components) are implemented by any combination of at least one of hardware and software. Moreover, the method of implementing each functional block is not particularly limited. That is, each functional block may be implemented using one device physically or logically coupled, or directly or indirectly using two or more physically or logically separated devices (e.g., a wired type, a wireless type, or the like) and may be implemented using these multiple devices. A functional block may be implemented by combining software in the one or more devices described above.

Although functions include judging, deciding, determining, calculating, producing, processing, deriving, examining, searching, checking, receiving, transmitting, outputting, accessing, resolving, selecting, choosing, establishing, comparing, assuming, expecting, regarding, broadcasting, notifying, communicating, forwarding, configuring, reconfiguring, allocating, assigning, and the like, the present disclosure is not limited thereto. For example, a functional block (component) that performs transmission is called a transmitting unit or transmitter. In either case, as described above, the implementation method is not particularly limited.

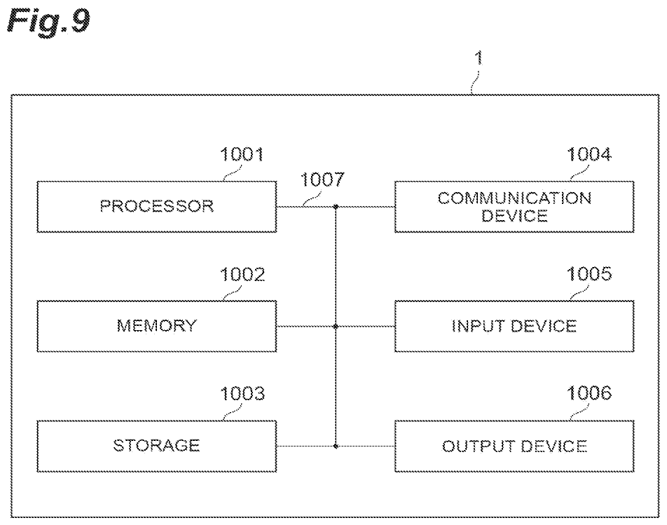

For example, the computer 1 in an embodiment of the present disclosure may function as a computer that processes information of the present disclosure. FIG. 9 is a diagram showing an example of a hardware configuration of the computer 1 according to the embodiment of the present disclosure. The computer 1 described above may be physically configured as a computer device including a processor 1001, a memory 1002, a storage 1003, a communication device 1004, an input device 1005, an output device 1006, a bus 1007, and the like.

Also, in the following description, the term “device” can be read as a circuit, a unit, or the like. The hardware configuration of the computer 1 may be configured to include one or more of the devices shown in FIG. 9, or may be configured without some devices.

Each function in the computer 1 is implemented by causing the processor 1001 to read predetermined software (program) on hardware such as the processor 1001 and the memory 1002, to perform a calculation process of the processor 1001, to control communication by the communication device 1004, or to control reading and/or writing data in the memory 1002 and the storage 1003.

The processor 1001, for example, operates an operating system to control the entire computer. The processor 1001 may include a central processing unit (CPU) including interfaces with peripheral devices, control devices, calculation devices, registers, and the like. For example, each function of the computer 1 may be implemented by the processor 1001.

Moreover, the processor 1001 reads programs (program codes), software modules, and data from the storage 1003 and/or the communication device 1004 to the memory 1002, and performs various types of processes in accordance therewith. For the program, a program that causes a computer to execute at least a portion of the operation described in the above-described embodiments is used. For example, each function of the computer 1 may be stored in the memory 1002 and implemented by a control program operating in the processor 1001 and other functional blocks may be similarly implemented. While the various types of processes described above have been described as being executed by one processor 1001, they may be executed simultaneously or sequentially by two or more processors 1001. The processor 1001 may be implemented by one or more chips. Also, the program may be transmitted from the network via a telecommunications circuit.

The memory 1002 is a computer-readable recording medium, and may include, for example, at least one of a read only memory (ROM), an erasable programmable ROM (EPROM), an electrically erasable programmable ROM (EEPROM), and a random-access memory (RAM). The memory 1002 may also be referred to as a register, a cache, a main memory (a main storage device), or the like. The memory 1002 is capable of storing programs (program codes), software modules, and the like capable of being executed to perform information processing according to an embodiment of the present disclosure.

The storage 1003 is a computer-readable storage medium. The storage 1003 may include, for example, at least one of an optical disc, such as a compact disc ROM (CD-ROM), a hard disk drive, a flexible disk; an optical magnetic disk (e.g., a compact disc, a digital versatile disc, or a Blu-ray (registered trademark) disc), a smart card; a flash memory (e.g., a card, a stick, or a key drive), a floppy (registered trademark) disk, a magnetic strip, or the like. The storage 1003 may be referred to as an auxiliary memory device. The storage medium provided in the computer 1 may be, for example, a database including at least one of the memory 1002 and the storage 1003, a database, a server, or another suitable medium.

The communication device 1004 is hardware (a transceiver device) for performing communication between computers via at least one of a wired network and a wireless network. The communication device 1004 is also referred to, for example, as a network device, a network control unit, a network card, a communication module, or the like.

The input device 1005 is an input device (e.g., a keyboard, a mouse, a microphone, a switch, a button, a sensor, or the like) that receives an external input. The output device 1006 is an output device (e.g., a display, a speaker, an LED lamp, or the like) that externally provides an output. Also, the input device 1005 and the output device 1006 may have an integrated configuration (e.g., a touch panel).

Moreover, devices such as the processor 1001 and the memory 1002 are connected by the bus 1007 for communicating information. The bus 1007 may be configured using a single bus or may be configured using different buses between the devices.

Moreover, the computer 1 may be configured to include hardware such as a microprocessor, a digital signal processor (DSP), an application specific integrated circuit (ASIC), a programmable logic device (PLD), and a field programmable gate array (FPGA), and some or all functional blocks may be implemented by the hardware. For example, the processor 1001 may be implemented by at least one of the above-described pieces of hardware.

The processing procedure, sequence, flowchart, and the like of the aspects/embodiments described in the present disclosure may be performed in a different order so long as no contradiction is incurred. For example, for a method described in the present disclosure, elements of various devices are described in illustrative order, and the described order should not be taken as a specific limitation.

Input or output information and the like may be stored in a predetermined location (for example, a memory) or may be managed using a management table. Input or output information and the like can be overwritten or updated, or information may be added thereto. Output information and the like may be deleted. Input information and the like may be transmitted to another device.

Determination may be made by a value represented by one bit (0or 1), may be made by a Boolean value (Boolean: true or false), or may be made by comparison of numerical values (e.g., comparison with a predetermined value).

Each aspect/embodiment described in the present disclosure may be used alone; may be combined to be used; or may be switched in accordance with execution. Furthermore, the notification of predetermined information (e.g., the notification indicating that “it is X”) is not limited to the notification that is made explicitly; and the notification may be made implicitly (e.g., the notification of the predetermined information is not performed).

Although the present disclosure has been described in detail above, it is clear to those skilled in the art that the present disclosure is not limited to the embodiments described in the present disclosure. The present disclosure can be practiced with modifications and variations without departing from the spirit and scope of the present disclosure as defined by the claims. Accordingly, the description of the present disclosure is for illustrative purposes and is not meant to be limiting in any way.

Regardless of whether it is referred to as software, firmware, middleware, microcode, hardware description language, or another name, the software should be interpreted broadly so as to imply a command, a command set, a code, a code segment, a program code, a program, a subprogram, a software module, an application, a software application, a software package, a routine, a subroutine, an object, an executable file, an execution thread, a procedure, a function, and the like.

Moreover, software, a command, and the like may be transmitted and received through a transmission medium. For example, when the software is transmitted from a Web site, a server, or another remote source using at least one of wired technology, such as a coaxial cable, an optical fiber cable, a twisted pair, and a digital subscriber line (DSL), and wireless technology, such as infrared, radio, and microwave, at least one of the wired technology and wireless technology is included within the definition of the transmission medium.

The terms “system” and “network” used in the present disclosure are used interchangeably.

Also, the information, parameters, and the like, which are described in the present disclosure, may be represented by absolute values, may be represented as relative values from predetermined values, or may be represented by any other corresponding information.

The terms “determining” and “deciding” used in the present disclosure may include various types of operations. For example, “determining” and “deciding” may include deeming that a result of calculating, computing, processing, deriving, investigating, looking up, search, and inquiry (e.g., search in a table, a database, or another data structure), or ascertaining is determined or decided. Moreover, “determining” and “deciding” may include, for example, deeming that a result of receiving (e.g., reception of information), transmitting (e.g., transmission of information), input, output, or accessing (e.g., accessing data in memory) is determined or decided. Moreover, “determining” and “deciding” may include deeming that a result of resolving, selecting, choosing, establishing, or comparing is determined or decided. Namely, “determining” and “deciding” may include deeming that some operation is determined or decided. Moreover, “determining (deciding)” may be read as “assuming,” “expecting,” “considering,” or the like.

The terms “connected,” “coupled,” or any variation thereof, mean any direct or indirect connection or coupling between two or more elements and can include the presence of one or more intermediate elements between two elements being “connected” or “coupled.” Couplings or connections between elements may be physical, logical, or a combination thereof. For example, “connection” may be read as “access.” As used in the present disclosure, two elements are defined to be “connected” or “coupled” to each other using at least one of one or more wires, cables, and printed electrical connections and, as some non-limiting and non-exhaustive examples, in the radio frequency domain, electromagnetic energy having wavelengths in the microwave and optical (both visible and invisible) regions, and the like.

The expression “on the basis of” used in the present specification does not mean “on the basis of only” unless otherwise stated particularly. In other words, the expression “on the basis of” means both “on the basis of only” and “on the basis of at least.”

Any reference to elements using names, such as “first” and “second,” which are used in the present disclosure, does not generally limit the quantity or order of these elements. These names are used in the specification as a convenient method for distinguishing two or more elements. Accordingly, the reference to the first and second elements does not imply that only the two elements can be adopted here, or does not imply that the first element must precede the second element in any way.

As long as “include,” “including,” and the variations thereof are used in the present disclosure and the claims, these terms are intended to be inclusive, similar to the term “comprising.” Furthermore, it is intended that the term “or” used in the present disclosure or the claims is not “exclusive OR.”

In the present disclosure, if articles, such as a, an, and the in English, are added according to translation, the present disclosure may include that the nouns following these articles have plural forms.

In the present disclosure, the term “A and B are different” may mean “A and B are different from each other.” The term may also mean that “A and B are different from C.” Terms such as “separate,” “coupled,” and the like may also be interpreted like the term “different.”

### REFERENCE SIGNS LIST

1 Computer
10 Population state determination system
11 Acquisition unit
12 Model calculation unit
13 Determination unit
20 Model generation system
21 Learning acquisition unit
22 Model generation unit
1001 Processor
1002 Memory
1003 Storage
1004 Communication device
1005 Input device
1006 Output device
1007 Bus

1. A population state determination system comprising circuitry configured to:
acquire population information indicating a population in a time series in an area that is a population state determination target;
perform calculation by inputting the acquired population information to a pre-stored encoder-decoder model for compressing and reconstructing input data and obtain an output from the encoder-decoder model; and
determine a state of the population in the area by comparing the acquired population information with the obtained output.

2. The population state determination system according to claim 1,
wherein the circuitry type information indicating a type of area that is the population state determination target, and
performs the calculation using the encoder-decoder model on the basis of the acquired type information.

3. The population state determination system according to claim 2, wherein the circuitry also inputs the type information to the encoder-decoder model and obtains the output from the encoder-decoder model.

4. The population state determination system according to claim 2, wherein the circuitry selects the encoder-decoder model for use in the calculation from a plurality of encoder-decoder models stored in advance on the basis of the type information and performs the calculation using the selected encoder-decoder model.

5. A model generation system comprising circuitry configured to:
acquire population information for learning indicating a population in a time series for use in generating an encoder-decoder model for compressing and reconstructing input data; and
generate the encoder-decoder model for inputting information indicating a population in a time series by performing machine learning on the basis of the acquired population information for learning.

6. The model generation system according to claim 5,
wherein the circuitry acquires type information for learning indicating a type of area pertaining to the population information for learning, and
generates the encoder-decoder model on the basis of the acquired type information for learning.

7. The model generation system according to claim 6, wherein the circuitry generates the encoder-decoder model to which type information indicating a type of area is also input.

8. The model generation system according to claim 6, wherein the circuitry generates a plurality of encoder-decoder models corresponding to type information indicating a type of area.

9. The model generation system according to claim 6, wherein the circuitry acquires the type information for learning by performing clustering using the population information for learning.

10. The population state determination system according to claim 3, wherein the circuitry selects the encoder-decoder model for use in the calculation from a plurality of encoder-decoder models stored in advance on the basis of the type information and performs the calculation using the selected encoder-decoder model.

11. The model generation system according to claim 7, wherein the circuitry generates a plurality of encoder-decoder models corresponding to type information indicating a type of area.
